(19) United States
(12) Patent Application Publication
(10) Pub. No.: US 2023/0176286 A1
(43) Pub. Date: Jun. 8, 2023

(54) OPTICAL COMPONENTS AND OPTICAL CONNECTORS HAVING A SPLICE-ON CONNECTION AND METHOD OF FABRICATING THE SAME

(71) Applicant: Corning Research & Development Corporation, Corning, NY (US)

(72) Inventors: Lars Martin Otfried Brusberg, Corning, NY (US); Qi Wu, Painted Post, NY (US)

(21) Appl. No.: 17/994,612

(22) Filed: Nov. 28, 2022

Related U.S. Application Data
(60) Provisional application No. 63/286,706, filed on Dec. 7, 2021.

(51) Int. Cl. G02B 6/255

(52) U.S. Cl. CPC G02B 6/2552; G02B 6/2555

(57) ABSTRACT

Optical components and optical connectors for optical communication are disclosed. In one embodiment, an optical component includes a substrate having a lens surface, a fiber coupling surface, and an array of lenses at the lens surface. The optical component further includes an array of optical fibers bonded to the fiber coupling surface such that the array of optical fibers is aligned with the array of lenses in a plane defined by the fiber coupling surface.

### CROSS REFERENCE TO RELATED APPLICATIONS

This application claims the benefit of priority of U.S. Provisional Application Ser. No. 63/286,706, filed on Dec. 7, 2021, the content of which is relied upon and incorporated herein by reference in its entirety.

### FIELD

The disclosure is directed to optical connectors and, more particularly, to optical components and optical connectors having optical fiber stubs or optical fiber pigtails bonded to a lens substrate.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G, and the like. As optical fiber extends deeper into communication networks there exists a need for building more complex and flexible fiber optic networks in a quick and easy manner.

Optical connectors are used to connect optical cables and optical components. For single and multi-fiber connectors, physical contact connectors like LC, MPO/MTP are widely used for different applications (telecom, datacom). Particularly for single-mode with fiber core diameter of approximately 10 microns, the cleanliness of the optical path is very important to achieve low loss (e.g., <0.35 dB insertion loss). Physical contact is achieved by applying mechanical force (e.g., 10N-20N) to overcome the dimensional variations to achieve low return loss of <−55 dB. With increasing number of fibers for high-density connectors with more than 24 fibers providing 24 optical channels, the mechanical force has to be increased to 20N or above to achieve physical contact. For very low loss, very precise fiber ferrules are required, which need to be assembled to the cable. This multi-step assembly process that includes adhesive bonding and fiber end-face polishing is mostly done manually because it is difficult to automate. For some application, like trunk cables, many of the same connectors need to be attached to the same cable. Then, the cable has to be moved from one assembly step to the next.

Lensed connectors for single-mode are a potential alternative to relax required mating force and cleanliness requirements. Current lensed connectors use a polymer injection molded ferrule, which makes them less reliable for high-power applications like external laser modules for co-packaged optics. Additionally, fiber orientation for polarization maintaining fibers is difficult to achieve.

Thus, alternative optical connectors having a large number of optical channels may be desired.

### SUMMARY

In one embodiment, an optical component includes a substrate having a lens surface, a fiber coupling surface, and an array of lenses at the lens surface. The optical component further includes an array of optical fibers bonded to the fiber coupling surface such that the array of optical fibers is aligned with the array of lenses in a plane defined by the fiber coupling surface, and an optical beam has an expanded beam diameter that is less than 100 μm at a surface of each lens of the array of lenses.

In another embodiment, an optical connector includes at least one optical component and ferrule. The at least one optical component a substrate includes a lens surface, a fiber coupling surface, an array of lenses at the lens surface, and an array of optical fibers bonded to the fiber coupling surface such that the array of optical fibers is aligned with the array of lenses in a plane defined by the fiber coupling surface, and an optical beam has an expanded beam diameter that is less than 100 μm at a surface of each lens of the array of lenses. The ferrule includes a front face having an opening, a substrate slot, and a fiber channel. The substrate is disposed within the substrate slot such that the lens surface is exposed by the opening. The array of optical fibers is disposed within the fiber channel.

In yet another embodiment, a method a fabricating an optical component includes placing an end of at least one optical fiber proximate a fiber coupling surface of a substrate. The substrate further includes a lens surface opposite from the fiber coupling surface, wherein the lens surface has at least one lens. The method also includes propagating an optical signal through the at least one optical fiber and into the substrate, and actively aligning the substrate with respect to the at least one optical fiber to an alignment position by detecting an optical power of the optical signal passed through the at least one lens. The alignment position is indicated by a position providing a maximum detected optical power of the optical signal. The method also includes bonding the at least one optical fiber to the fiber coupling surface at the alignment position.

In yet another embodiment, a method of fabricating an optical connector includes fabricating at least one optical component by placing an end of at least one optical fiber proximate a fiber coupling surface of a substrate. The substrate further includes a lens surface opposite from the fiber coupling surface, wherein the lens surface has at least one lens. Fabricating the at least one optical component further includes propagating an optical signal through the optical fiber and into the substrate, and actively aligning the substrate with respect to the at least one optical fiber to an alignment position by detecting the optical beam of the optical signal passed through the at least one lens. The alignment position is indicated by a position provided by detector feedback of the optical signal. Fabricating the at least one optical component also includes bonding the at least one optical fiber to the fiber coupling surface at the alignment position. The method further includes positioning the substrate within a substrate slot of a ferrule and the at least one optical fiber within a fiber channel of the ferrule.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 illustrates two example optically coupled optical components according to one or more embodiments described and illustrated herein;

FIG. 2 illustrates an example substrate having a lensed surface according to one or more embodiments described and illustrated herein;

FIGS. 3A-3D illustrates an example optical fiber preparation process according to one or more embodiments described and illustrated herein;

FIG. 4 illustrates an example active alignment process for aligning an optical fiber with a lens of a substrate according to one or more embodiments described and illustrated herein;

FIG. 5 illustrates an example laser bonding process to bond an optical fiber to a fiber coupling surface of a substrate according to one or more embodiments described and illustrated herein;

FIG. 6 illustrates further securing an optical fiber to a fiber coupling surface of a substrate using adhesive according to one or more embodiments described and illustrated herein;

FIG. 7 illustrates an example process of fabricating a fiber stub by pulling an optical fiber such that it breaks at a score according to one or more embodiments described and illustrated herein;

FIG. 8 illustrates an example optical component comprising an array of fiber stubs and a substrate having an array of lenses according to one or more embodiments described and illustrated herein;

FIG. 9 illustrates a perspective view of an example optical component comprising an array of fiber stubs and a substrate having an array of lenses according to one or more embodiments described and illustrated herein;

FIG. 10 illustrates an example optical connector sub-assembly comprising an optical component and a ferrule according to one or more embodiments described and illustrated herein;

FIG. 11 illustrates a perspective view of an example optical component comprising an array of fiber stubs and a substrate having an array of lenses, and an array of fibers that are spliced to the fiber subs of the optical component according to one or more embodiments described and illustrated herein;

FIG. 12 illustrates an example optical connector according to one or more embodiments described and illustrated herein;

FIG. 13 illustrates an example ferrule of an optical connector according to one or more embodiments described and illustrated herein;

FIG. 14 illustrates a perspective optical connector according to one or more embodiments described and illustrated herein;

FIG. 15 illustrates a front elevation view of the optical connector of FIG. 14 according to one or more embodiments described and illustrated herein;

FIG. 16A illustrates an optical connector wherein a splice is within a ferrule according to one or more embodiments described and illustrated herein;

FIG. 16B illustrates an optical connector without a splice in the ferrule according to one or more embodiments described and illustrated herein;

FIG. 17A illustrates an optical jumper cable having a first optical connector with a splice within a ferrule and a second optical connector wherein there is no splice within the ferrule according to one or more embodiments described and illustrated herein;

FIG. 17B illustrate an optical jumper cable having two optical connectors having a splice within a ferrule according to one or more embodiments described and illustrated herein;

FIG. 18A illustrates an example optical cable having optical connectors with a splice in a ferrule according to one or more embodiments described and illustrated herein; and

FIG. 18B illustrates an example optical cable having optical connectors without a splice in a ferrule according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

The concepts disclosed are related to optical components and optical connectors configured as splice-on connectors with beam collimation for fabrication of low-loss one-dimensional or two dimensional fiber array connectors. Optical fiber end-faces are permanently attached to an optical substrate on one surface. The optical substrate is a transparent substrate with lenses or a metasurface on the opposite surface. Each optical fiber is individually aligned (e.g., by active alignment) to the optical component (e.g. lens), for best position of each optical channel avoiding tolerance stacks which lead to higher loss. Each optical channel has optimized alignment independent of fiber geometry resulting in lowest optical loss independent on number of optical fibers.

Various embodiments optical components, optical connectors, and methods of fabricating the same are described in detail below.

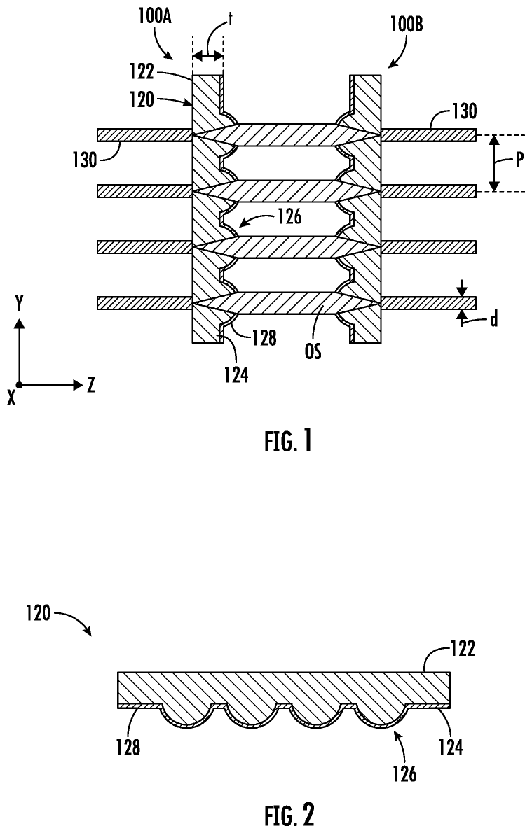

Referring now to FIG. 1, a first optical component 100A optically coupled to a second optical component 100B is schematically illustrated. Both the first optical component 100A and the second optical component 100B share identical parts and configuration in the illustrated example. The components of the first and second optical components 100A, 100B will be described by reference to the first optical component 100A. However, it should be understood that the same components apply to the second optical component 100B.

The first optical component includes a substrate 120 having fiber coupling surface 122 and a lens surface 124. The substrate 120 has a thickness t, which may be, without limitation, 0.3 mm to 1.2 mm, including endpoints. The material chosen for the substrate 120 should be transparent to the wavelength of an optical signal OS being propagated. As used herein, “transparent” means that less than 10% of an optical power of the optical signal OS is absorbed by the substrate 120.

Embodiments are not limited by any particular type of material for the substrate 120. It may be preferable to choose the material of the substrate 120 such that it matches the material of the optical fibers 130 (described in more detail below) For example, both the optical fibers 130 and the substrate 120 may be fused silica. The matching fused silica material provides very low loss coupling and very low back reflection due to the same refractive index. Further, having both the optical fibers 130 and substrate 120 be fused silica provides for an interface with a matching of coefficient of thermal expansion (CTE), which reduces the mechanical stress and increases the long-term reliability. Fused silica has a low CTE=0.55 ppm/C, with reduced expansion over wide range of temperature (T=−45 C to +125° C.).

The lens surface 124 has at least one lens 126. In the illustrated embodiment, the substrate 120 has an array of lenses 126, such as a one dimensional or two-dimensional array of lenses 126. The at least one lens 126 may be fabricated into the lens surface 124 by any method. As non-limited examples the at least one lens 126 may be formed by lithography and reactive ion etching (RIE), polymer photoresist, deposition and re-melting, embossing, ink-jet printing, dispensing of very small optical adhesive volumes, and/or the like. The shape of the at least one lens may be spherical, non-spherical, Fresnel, or any other shape or configuration. The at least one lens 126 can be made on a wafer or panel level. Lens arrays can be diced, or laser cut before the fiber bonding process described below or after the fiber bonding process.

The dimensions of the at least one lens 126 are not limited by this disclosure. As a non-limiting example, the radius of curvature of the at least one lens 126 may be within a range of 0.05 mm and 0.5 mm, including endpoints. As a further non-limiting example, the diameter of the at least one lens 126 may be about 240 μm for a 250 μm pitch P between optical fibers 130 or smaller dependent on optical fiber diameter. For example, reduced cladding optical fibers (e.g., 80 μm diameter or less) enables high-density lens arrays. An another example, the lens diameter may be 100 μm to 250 μm, including endpoints. In some embodiments, the lens surface 124 is coated with an anti-reflection coating 128 for a specific wavelength range depending on the application. Any other optical features for beam shaping are possible, as well as meta-surfaces, filters, or combinations thereof. Aside from single-mode, few-mode and multi-mode are also possible as well as polarization maintaining fibers or any special fiber designs.

The at least one optical fiber 130 is bonded to the fiber coupling surface 122. Embodiments are not limited by the type of optical fiber 130. As stated above, the optical fiber 130 may be made of fused silica. The optical fiber 130 can be any single-mode, multimode, polarization maintaining, or other specialty optical fiber. The optical fiber 130 can be provided from a spool with hundreds of meters of optical fiber length, for example. One end of the optical fiber 130 can be connectorized and coupled to a light source, for example. As described in more detail below, the at least one optical fiber 130 is two-dimensionally aligned (e.g., in x- and y-direction) with the at least one optical lens 126 on a plane defined by the fiber coupling surface 122. In other words, the at least one optical fiber is bonded to the fiber coupling surface 122 at an alignment position that provides the lowest optical loss of the optical signal OS passing through the at least one lens 126. In some cases, a center of the at least one optical fiber 130 (i.e., a center of the core of the optical fiber) is aligned with a center the at least one lens 126. The alignment may be within ±1 μm, for example. However, in some embodiments it may be desirable for there to be a slight misalignment between the center of the at least one optical fiber 130 and the center of the at least one lens 126 to prevent back reflections of the optical beam. As a non-limiting example, the center of the at least one optical fiber 130 and the center of the at least one lens 126 may be intentionally mis-aligned by 100 μm or less with the center of the at least one lens 126 to angle the expanded optical beam by 15 degrees or less.

As shown in FIG. 1, an array of optical fibers 130 and an array of lenses 126 may provide an array of optical channels defined by a plurality of optical signals OS. Each optical signal is emitted from an optical fiber 130 at an interface between the optical fiber 130 and the fiber coupling surface 124 where it becomes an expanding beam within the bulk of the substrate 120. A lens collimates the optical signal OS where it then propagates in free space as an expanded beam. As a non-limiting example, a diameter of the expanded beam may be between 20 μm and 240 μm, including end points. The expanded beam is then received by a coupled lens 126 of an opposing substrate 120 of a coupled optical component (e.g., second optical component 100B) which then focuses the optical signal such that it enters a coupled optical fiber 130.

FIGS. 2-10 illustrate a process to fabricate an optical component as well as an optical connector that includes an optical component as illustrated by FIG. 1.

Referring now to FIG. 2, a substrate 120 having a lens surface 124 with at least one lens 126 and a fiber coupling surface 122 is provided. As stated above, the substrate 120 may be diced from a wafer having an array of lenses 126 formed therein. In some embodiments, an anti-reflection coating 128 is applied to at least the array of lenses 126 or the entire lens surface 124.

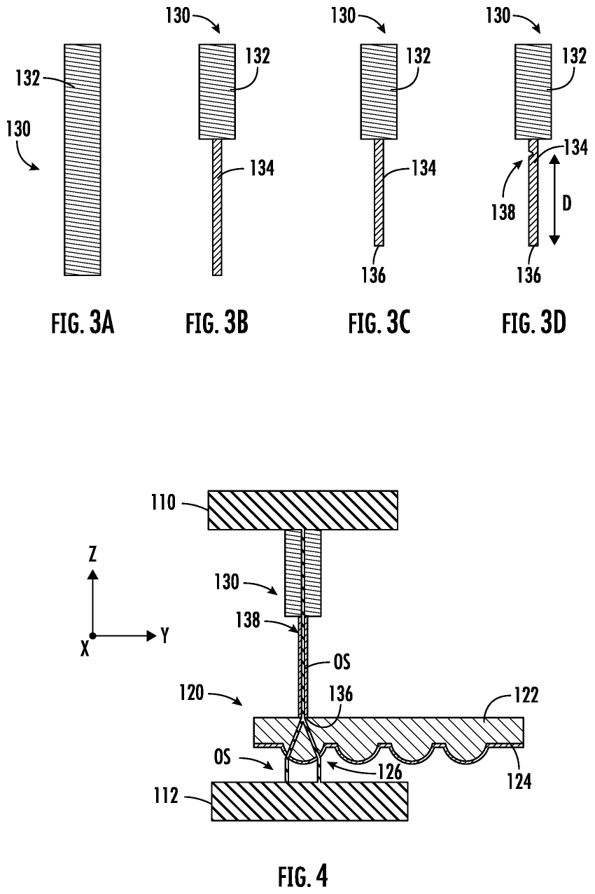

FIGS. 3A-3D illustrate fiber stub preparation for the optical component 100. FIG. 3A illustrates an optical fiber 130 having an outer coating 132, such as a polymer coating. The optical fiber 130 may be any type of optical fiber having any type of outer coating or jacket. First, a portion of the outer coating 132 is stripped away by any known or yet-to-be-developed stripping process to reveal the cladding 134 of the optical fiber 130, as shown in FIG. 3B. Next, a portion of the exposed optical fiber 130 is cleaved by a cleaving process to produce a clean end 136 of the optical fiber 130 as shown in FIG. 3C. The cleaving process may be mechanical or by laser cleaving, for example. Further, the cladding 134 of the optical fiber 130 may be scored to leave a score 138 at a defined distance D from the end 136 of the optical fiber 130. As described in more detail below, the optical fiber 130 is broken at the score 138 to produce fiber stubs 135 (FIG. 3D). The distance D determines how long the fiber stub 135 will be. As a non-limiting example, the distance D may be greater than 5 mm, greater than 10 mm, or greater than 15 mm depending on the application. The process of preparing the optical fibers 130 for bonding to the substrate 120 may be performed manually or by an automated process.

After the optical fibers 130 are prepared, they are ready to be bonded to the fiber coupling surface 122 of the substrate 120. FIG. 4 illustrates an example process of using active alignment to locate the optimal alignment position of the optical fiber 130 with respect to a corresponding lens 126. The optical fiber 130 is located on the fiber coupling surface 122 such that it is coarsely vertically aligned with a lens. Vertically aligned means that the end 136 of the optical fiber 130 is aligned in two directions (e.g., the x- and y-directions shown in FIG. 4) in a plane defined by the fiber coupling surface 122.

An active alignment process may be utilized to find the alignment position of the optical fiber 130, which is the position of the optical fiber on the fiber coupling surface 122 that provides the lowest optical loss. An end of the optical fiber 130 that is opposite end 136 is coupled to a light source 110, such as a laser light source, that injects an optical signal OS (e.g., an optical beam) into the optical fiber 130. The optical signal OS passes through the interface between the end 136 of the optical fiber 130 and the fiber coupling surface 122 of the substrate 120, where it then diverges. The corresponding lens 126 that is aligned with the optical fiber 130 collimates the optical signal OS. A detector 112, such as a beam analyzer, receives the optical signal OS (i.e., the expanded optical beam) exiting the lens 126 and measures its mode-field or optical power. The substrate 120 is moved in two directions (e.g., by a translation table) while the detector 112 measures the mode-field or optical power of the optical signal OS according to an active alignment routine. The position of the substrate 120 with respect to the end 136 of the optical fiber 130 providing the specified mode-field of the received beam or greatest optical power of the optical signal OS as detected by the detector (i.e., the detector feedback) is the alignment position.

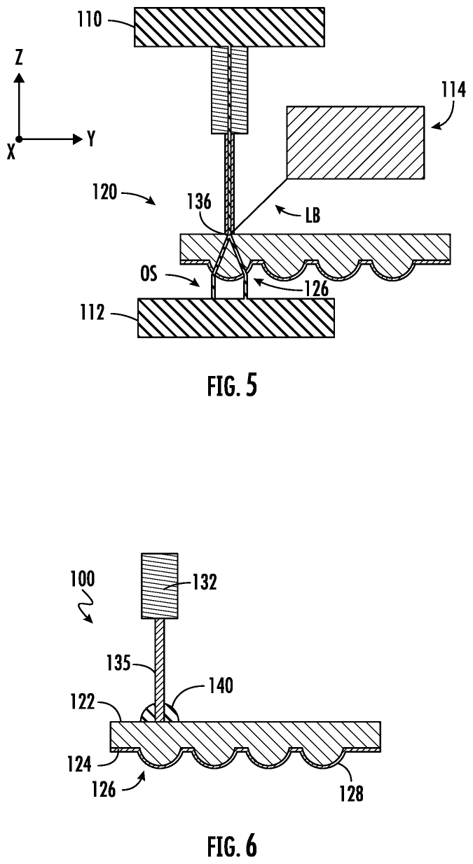

Once the optical fiber 130 is aligned, the end 136 of the optical fiber 130 is permanently bonded to the fiber coupling surface 122 of the substrate 120. As shown in FIG. 5, the optical fiber 130 may be bonded to the fiber coupling surface 122 by a laser beam LB provided by a laser source 114. As a non-limiting example, the laser source 114 may be a CO₂ laser with continuous wave or pulsed that melts both the optical fiber 130 and the fiber coupling surface 122 to permanently bond the optical fiber 130 to the substrate 120. One or multiple laser beams with same or different beam diameter, wavelength and focus point can be applied to the fiber coupling area. Any known or yet-to-be-developed method of laser bonding the optical fiber 130 to the substrate 120 may be utilized. In other embodiments, adhesive or sodium silicate may be used to permanently bond the end 136 of the optical fiber 130 to the fiber coupling surface 122. Non-limiting example adhesives include epoxy, polyurethane polyimide The bonding of the end 136 of the optical fiber 130 to the substrate 130 closes the air gap between the end 136 of the optical fiber 130 and the fiber coupling surface 122, and provides an index-matched interface between the end 136 of the optical fiber 130 and the fiber coupling surface 122. There is low optical loss between the bonded optical fiber 130 and the lens 126, such as less than 0.5 dB loss, less than 0.4 dB loss, less than 0.35 dB loss, or less than 0.3 dB loss

In some embodiments, no matter the bonding method, additional adhesive 140 may be locally applied near the bonding region to increase the strength (i.e., pull force) of the optical fiber 130 to the fiber coupling surface 122. However, in other embodiments, no additional adhesive 140 is provided.

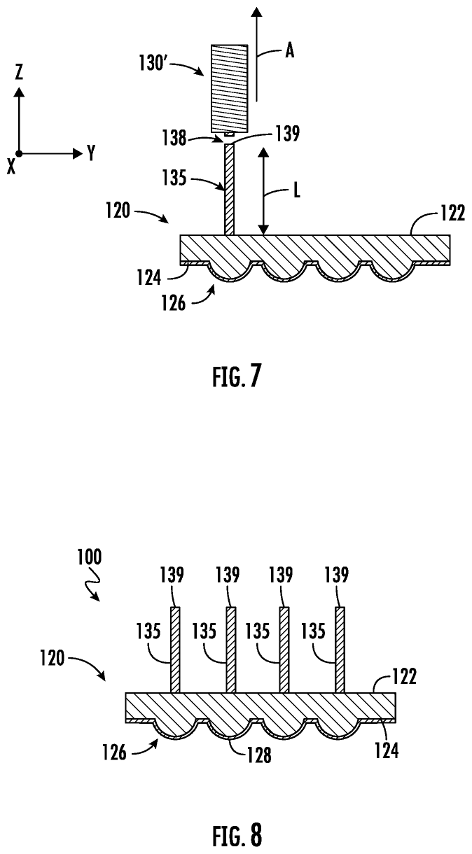

Referring now to FIG. 7, the optical fiber 130 can be shortened to form a fiber stub 135. As an example, the optical fiber 130 may be pulled in direction indicated by arrow A to break the optical fiber 130 at the score 138. A fiber stub 135 remains vertical in reference to the plane defined by the fiber coupling surface 122 of the substrate. In another example, the optical fiber 130 can be cleaved at the desired location to form the fiber stub 135. The fiber stub 135 has a tip 139 that may be spliced to another optical fiber, as described in more detail below.

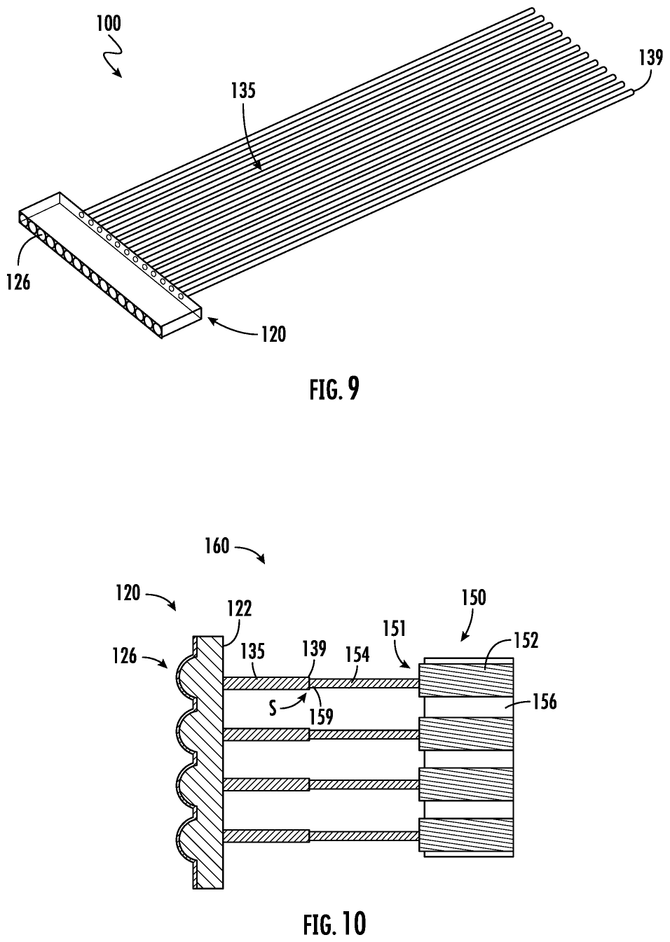

FIG. 8 illustrates an optical component 100 having four fiber stubs 135 bonded to a fiber coupling surface 122 of a substrate 120. It should be understood that any number of fiber stubs 135 and corresponding lenses 126 may be used. The fiber stubs 135 and lenses 126 may be arranged in a one dimensional array or a two dimensional array. FIG. 9 is a perspective view of an optical component 100 having twelve fiber stubs 135 and twelve corresponding lenses 126. FIG. 9 further shows additional unused lenses 126 on both ends of the substrate that may be used for precision alignment. Precision machining of the substrate 120 (e.g. laser, dicing) may be applied to obtain micron levels of dimensional control.

The optical component 100 may be incorporated into an optical connector. FIG. 10 illustrates the example optical component 100 coupled to an optical fiber ribbon cable 150 to form an optical connector sub-assembly 160. The optical fiber ribbon cable 150 includes a plurality of ribbon optical fibers 151 having an exposed core portion 154 and an outer coating (e.g., a polymer coating). The plurality of ribbon optical fibers 151 are maintained together by a ribbon coating 156, which may also be a polymer.

The ends 159 of the ribbon optical fibers 151 may be spliced to the tips 139 of the fiber stubs 135 to couple the fiber stubs 135 to the ribbon optical fibers 151. Any known or yet-to-be-developed method of forming a splice S between the fiber stubs 135 and the ribbon optical fibers 151 may be used. For example, splice equipment can be utilized which aligns the respective fiber cores and fusion bonds the fiber stub 135 to the ribbon optical fiber 151, which can be part of a single ribbon or high fiber count cable. This process can be repeated for all optical fibers of a ribbon cable. The splice S may provide a very low loss (e.g., 0.05 dB) between the fiber stubs 135 and the ribbon optical fibers 151. FIG. 11 illustrates an example optical connector sub-assembly 160 including an optical component 100 spliced to an optical fiber ribbon cable 150.

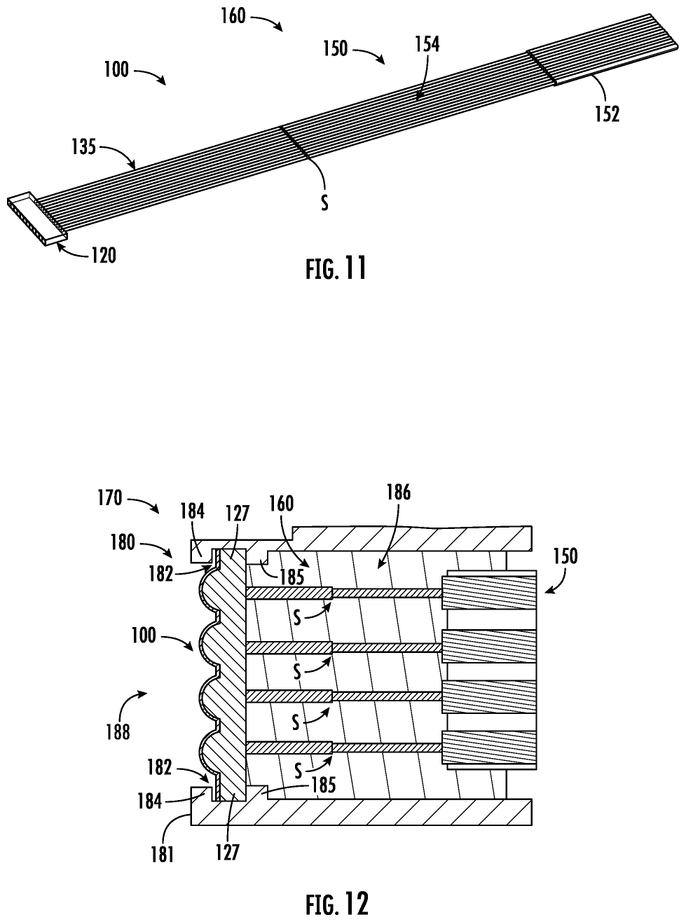

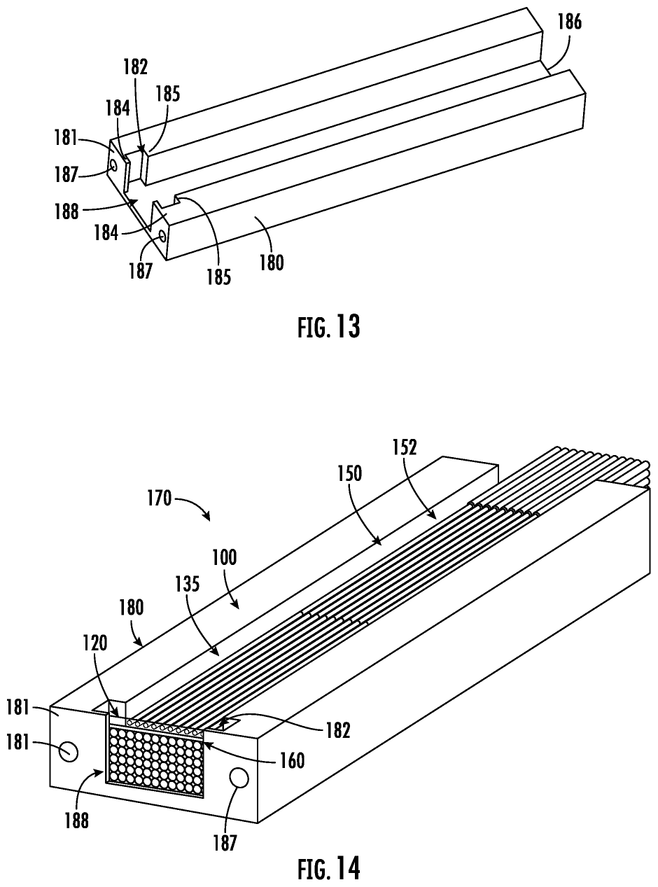

Referring now to FIG. 12, the optical connector sub-assembly 160 may be positioned within a ferrule 180 to form an optical connector 170. Embodiments are not limited by the type of ferrule that is used, which may depend on the end application. In some embodiments, the ferrule 180 is configured as MT-style ferrule. FIG. 13 illustrates a perspective view of an example ferrule 180 of FIG. 12. Referring to both FIGS. 12 and 13, example the ferrule 180 includes a front face 181, an opening 188 in the front face 181, a substrate slot 182, and a fiber channel 186. The substrate slot 182 is sized and configured to receive the substrate 120 of the optical component 100. The substrate slot 182 is defined by first and second walls 184, 185 that locate and maintain the substrate 120 in the proper location with respect to the ferrule 180. The opening 188 exposes the lenses 126 of the substrate 120 for optical coupling with a mated connector.

The front face 181 also has alignment bores 187 on opposite sides of the opening 188 for receiving alignment pins of a mated optical connector. The fiber channel 186 is sized and configured to receive the fiber stubs 135 and/or the stripped ribbon optical fibers 151. The substrate 120 and/or the ribbon optical fibers 151 may be secured within the ferrule 180 by an adhesive, for example.

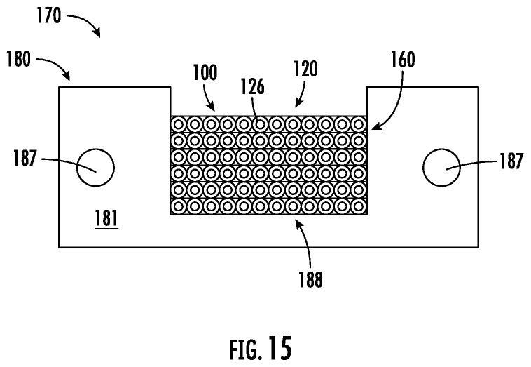

An optical connector having a two-dimensional array of lenses may be fabricated by stacking multiple optical connector sub-assemblies 160 on top of one another. FIGS. 14 and 15 illustrate an example optical connector 170 having a two dimensional array of lenses 126. The optical connector 170 has six sub-assemblies 160 in a stacked arrangement within the ferrule 180. The individual substrates 120 are stacked on one another within the substrate slot 182 to provide a two-dimensional array of lenses 126. Vertical alignment between the individual array of lenses 126 can be achieved by utilizing one or more of the substrate 120 surfaces. In some embodiments, spacers (not shown) may be disposed between the fiber stubs 135 to control the vertical distance (e.g., 250 μm or 500 μm). In some embodiments, spacers (not shown) may be disposed between stacked substrates to control the vertical distance between the lenses 126 (e.g. 250 μm)

Adhesive may be applied to fill all gaps inside of the ferrule 180 to protect the splice and the fiber-to-substrate interface. It is noted that the form factor of the ferrule 180 can be adjusted to fit more optical channels in each row or increase the number of rows, e.g., to make optical connectors with 144 channels, for example.

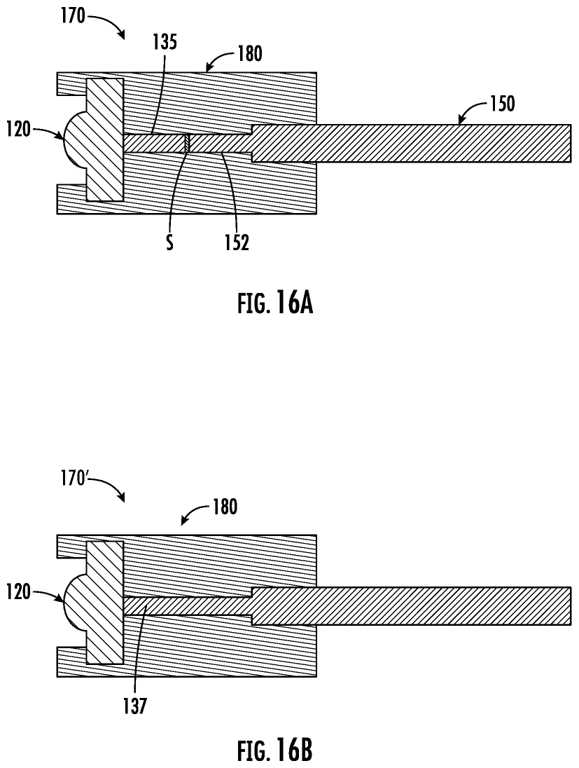

The splice S between the fiber stub 135 and the ribbon optical fiber 151 may be within the ferrule 180 or connector housing, or outside of the ferrule 180 or connector housing. FIG. 16A illustrates an example optical connector 170 wherein the splice S is within the ferrule 180. On the other hand, FIG. 16B illustrates an example optical connector 170′ wherein instead of a fiber stub, the fiber bonded to the substrate 120 is a pigtail or an array of optical fibers (e.g., fiber ribbon, fiber cable, and the like). In this example, the optical fibers are not broken after bonding to provide for a plurality of fiber stubs 137. The optical connector of FIG. 16B may lead to a reduced form factor because splice protection is not needed.

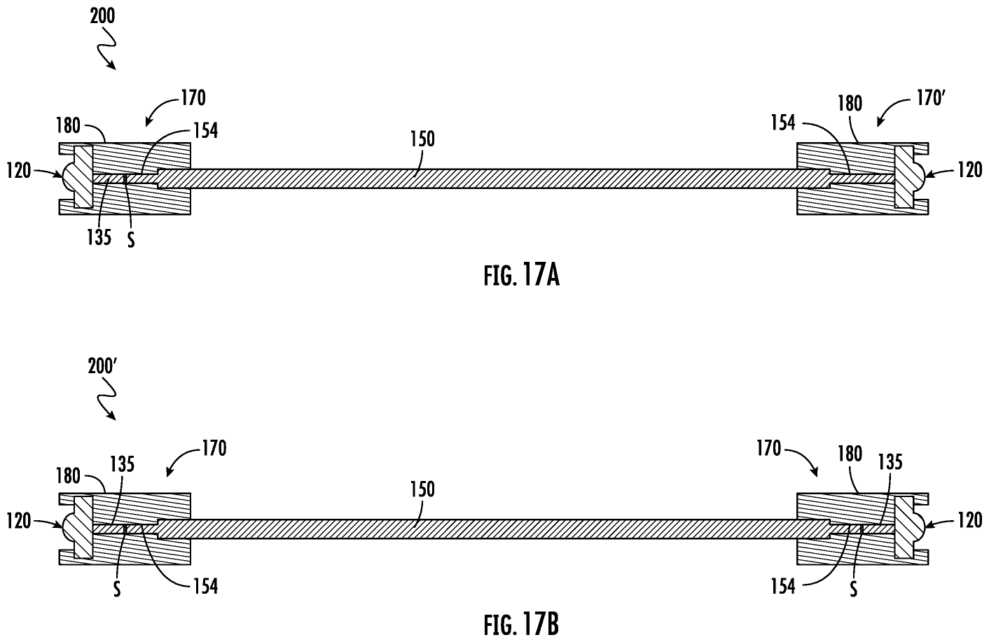

A combination of two splice-on fiber stub optical connectors as described above may be used to make a jumper cable. In some embodiments, one splice may be skipped by using a splice-on fiber pigtail connector (e.g., as shown by optical connector 170′ of FIG. 16A) and one splice-on fiber stub connector (e.g., the optical connector of FIG. 16B). FIG. 17A illustrates such an example optical jumper cable 200 where in a first optical connector 170, the splices S coupling optical fiber stubs 135 to the exposed core portions 154 of ribbon optical fibers of an optical fiber ribbon cable 150 are within the ferrule 180 (and/or connector housing (not shown)). In a second optical connector 170′, the exposed core portions 154 are directly coupled to the substrate 120, which saves splicing on one side of the optical jumper cable 200.

FIG. 17B illustrates another optical jumper cable 200′ having two splice-on fiber stub optical connectors 170 wherein the splices S within each optical connector 170 are within the ferrule 180 and/or connector housing (not shown).

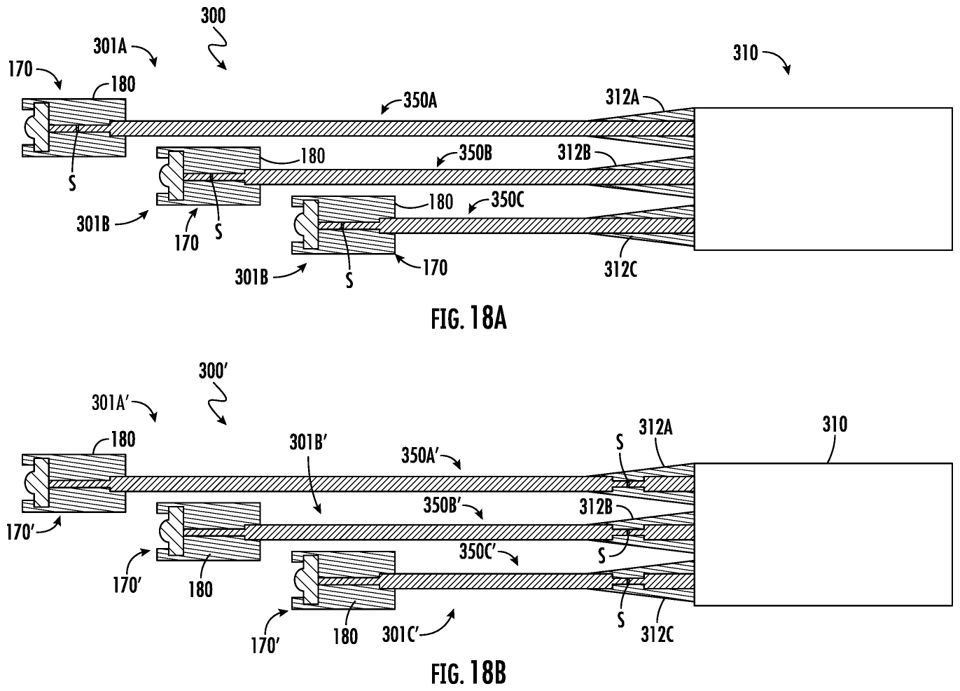

The optical connectors described herein may also be employed in optical cables (e.g. trunk cables) having multiple optical fiber ribbons. FIG. 18A illustrates an example cable assembly 300 having a first fiber optic cable assembly 301A, a second fiber optic cable assembly 301B, and a third fiber optic cable assembly 301C. The first fiber optic cable assembly 301A comprises a first fiber optic cable 350A extending from a first furcation housing 312A of a cable 310 and has a splice-on fiber stub optical connector 170 as described above wherein the splice S is within the ferrule 180 or connector housing. The second fiber optic cable assembly 301B comprises a second fiber optic cable 350B extending from a second furcation housing 312B of the cable 310 and has a splice-on fiber stub optical connector 170 as described above wherein the splice S is within the ferrule 180 or connector housing. The third fiber optic cable assembly 301C comprises a third fiber optic cable 350C extending from a third furcation housing 312C of the cable 310 and has a splice-on fiber stub optical connector 170 as described above wherein the splice S is within the ferrule 180 or connector housing. Because of the lensed design of the optical connectors 170, optical fiber end face polishing is not needed, the yield can be higher, and the number of parts to achieve coupling with a mated optical connector (e.g., springs, latches, and the like) can be reduced, which further reduces the size of the optical connectors 170 of the cable assembly 300.

FIG. 18B illustrates an example cable assembly 300′ configured with splice-on fiber pigtail optical connectors 170′ as described above. The cable assembly 300′ has a first fiber optic cable assembly 301A′, a second fiber optic cable assembly 301B′, and a third fiber optic cable assembly 301C′. The first fiber optic cable assembly 301A′ comprises a first fiber optic cable 350A′ extending from a first furcation housing 312A′ of a cable 310, and has a splice S within the first furcation housing 312A′ to couple the splice-on fiber pigtail optical connector 170′ to the optical fibers within the first furcation housing 312A′. The second fiber optic cable assembly 301B′ comprises a second fiber optic cable 350B′ extending from a second furcation housing 312B′ of the cable 310, and has a splice S within the second furcation housing 312B″ to couple the splice-on fiber pigtail optical connector 170′ to the optical fibers within the second furcation housing 312B′. The third fiber optic cable assembly 301C′ comprises a third fiber optic cable 350C′ extending from a third furcation housing 312C′ of a cable 310, and has a splice S is the third furcation housing 312C to couple the splice-on fiber pigtail optical connector 170′ to the optical fibers within the third furcation housing 312C′.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. An optical component comprising:
a substrate comprising a lens surface, a fiber coupling surface, and an array of lenses at the lens surface; and
an array of optical fibers bonded to the fiber coupling surface such that the array of optical fibers is aligned with the array of lenses in a plane defined by the fiber coupling surface, and an optical beam has an expanded beam diameter that is less than 100 μm at a surface of each lens of the array of lenses.

2. The optical component of claim 1, wherein the array of optical fibers is an array of fiber stubs.

3. The optical component of claim 1, wherein the array of optical fibers is provided by an optical fiber ribbon cable.

4. The optical component of claim 1, wherein a diameter of individual lenses of the array of lenses is within a range of 100 μm to 250 μm, including endpoints.

5. The optical component of claim 1, wherein a pitch between adjacent individual lenses of the array of lenses is within a range of 100 μm to 250 μm.

6. The optical component of claim 1, wherein a center of each optical fiber of the array of optical fibers is aligned with a center of a corresponding lens of the array of lenses.

7. The optical component of claim 1, wherein the center of the optical core is mis-aligned by 100 microns or less with the center of the optical lens to angle the expanded beam by 15 degrees or less.

8. An optical connector comprising:
at least one optical component comprising:
a substrate comprising a lens surface, a fiber coupling surface, and an array of lenses at the lens surface; and
an array of optical fibers bonded to the fiber coupling surface such that the array of optical fibers is aligned with the array of lenses in a plane defined by the fiber coupling surface, and an optical beam has an expanded beam diameter that is less than 100 μm at a surface of each lens of the array of lenses; and
a ferrule comprising:
a front face comprising an opening;
a substrate slot, wherein the substrate is disposed within the substrate slot such that the lens surface is exposed by the opening; and
a fiber channel, wherein the array of optical fibers is disposed within the fiber channel.

9. The optical connector of claim 8, wherein the array of optical fibers is provided by an optical fiber ribbon cable.

10. The optical connector of claim 8, wherein a diameter of individual lenses of the array of lenses is within a range of 100 μm to 250 μm, including endpoints.

11. The optical connector of claim 8, wherein a pitch between adjacent individual lenses of the array of lenses is within a range of 100 μm to 250 μm.

12. The optical connector of claim 8, wherein the substrate slot is wider than the fiber channel.

13. The optical connector of claim 8, wherein the array of optical fibers is an array of fiber stubs.

14. The optical connector of claim 13, further comprising an optical fiber ribbon cable comprising an array of ribbon optical fibers, wherein the array of ribbon optical fibers is spliced to the array of fiber stubs.

15. The optical connector of claim 14, wherein a splice between the array of ribbon optical fibers and the array of fiber stubs is within the fiber channel.

16. The optical connector of claim 14, wherein a splice between the array of ribbon optical fibers and the array of fiber stubs is outside of the fiber channel.

17. The optical connector of claim 8, wherein the front face of the ferrule further comprises a first alignment bore and a second alignment bore on opposite ends of the opening.

18. The optical connector of claim 8, wherein the at least one optical component comprises a plurality of optical components disposed within the ferrule such that individual substrates of each individual optical component of the plurality of optical components are stacked on one another within the substrate slot such that the optical connector comprises a two-dimensional array of lenses.

19. A method of fabricating an optical component, the method comprising:
placing an end of at least one optical fiber proximate a fiber coupling surface of a substrate, wherein the substrate further comprises a lens surface opposite from the fiber coupling surface, the lens surface comprising at least one lens;
propagating an optical signal through the at least one optical fiber and into the substrate;
actively aligning the substrate with respect to the at least one optical fiber to an alignment position by detecting the optical beam of the optical signal passed through the at least one lens, wherein the alignment position is indicated by a position provided by detector feedback of the optical signal;
bonding the at least one optical fiber to the fiber coupling surface at the alignment position or at defined lateral offset of 5 micron or less to the alignment position.

20. The method of claim 19, further comprising preparing the at least one optical fiber by stripping an outer coating of the at least one optical fiber, cleaving the at least one optical fiber.

21. The method of claim 20, further comprising scoring the at least one optical fiber a distance from the end to form a score.

22. The method of claim 21, further comprising, after bonding the at least one optical fiber to the fiber coupling surface, pulling the at least one optical fiber to break the at least one optical fiber at the score.

23. The method of claim 19, wherein the bonding of the at least one optical fiber to the fiber coupling surface comprises applying a laser beam to the end of the at least one optical fiber.

24. The method of claim 19, wherein the at least one optical fiber comprises a plurality of optical fibers and the at least one lens comprises an array of lenses.

25. The method of claim 19, further comprising splicing a second end of the at least one optical fiber to an array of optical fibers.

26. A method of fabricating an optical connector, the method comprising:
fabricating at least one optical component by:
placing an end of at least one optical fiber proximate a fiber coupling surface of a substrate, wherein the substrate further comprises a lens surface opposite from the fiber coupling surface, the lens surface comprising at least one lens;
propagating an optical signal through the optical fiber and into the substrate;
actively aligning the substrate with respect to the at least one optical fiber to an alignment position by monitoring the optical signal passed through the at least one lens, wherein the alignment position is indicated by a position provided by detector feedback of the optical signal; and
bonding the at least one optical fiber to the fiber coupling surface within 5 μm or less of the alignment position; and
positioning the substrate within a substrate slot of a ferrule and the at least one optical fiber within a fiber channel of the ferrule.

27. The method of claim 26, further comprising preparing the at least one optical fiber by stripping an outer coating of the at least one optical fiber, and cleaving the at least one optical fiber.

28. The method of claim 27, further comprising scoring the at least one optical fiber a distance from the end to form a score.

29. The method of claim 28, further comprising, after bonding the at least one optical fiber to the fiber coupling surface, pulling the at least one optical fiber to break the at least one optical fiber at the score.

30. The method of claim 26, wherein the bonding of the at least one optical fiber to the fiber coupling surface comprises applying a laser beam to the end of the at least one optical fiber.

31. The method of claim 26, wherein the at least one optical fiber comprises a plurality of optical fibers and the at least one lens comprises an array of lenses.

32. The method of claim 26, further comprising splicing a second end of the at least one optical fiber to an array of optical fibers.

33. The method of claim 26, wherein the at least one optical component comprises a plurality of optical components, and placing at least one substrate of the plurality of optical components into the substrate slot comprises stacking a plurality of substrates of the plurality of optical components with in the substrate slot.
